(19) United States
(12) Patent Application Publication
(10) Pub. No.: US 2006/0199453 A1
(43) Pub. Date: Sep. 7, 2006

(54) Modified bitumen and thermoplastic composite roofing membrane

(75) Inventors: William P. Kuhn, Boonton, NJ (US); Amir Khan, Wayne, NJ (US)

Correspondence Address: GAF MATERIALS CORPORATION;William J. Davis, Esq., Legal Dept., Bldg. 8-2, 1361 Alps Road, Wayne, NJ, 07470, US

(73) Assignee: BUILDING MATERIALS INVESTMENT CORPORATION

(21) Appl. No.: 11/429,082

(22) Filed: May 5, 2006

Related U.S. Application Data
(63) Continuation of application No. 10/841,045, filed on May 7, 2004.

(51) Int. Cl. B32B 27/04; B32B 27/12; D04H 11/00

(52) U.S. Cl. 442/38; 442/20; 442/41; 442/43; 442/44; 442/45; 442/46; 442/48; 442/49; 428/85; 428/86; 428/96; 428/97

(57) ABSTRACT

A composite roofing membrane having a top layer of a thermoplastic polymer, a middle layer of a fleece material, and a bottom layer of modified bitumen joined together. The top and bottom layers may be reinforced with a reinforcing scrim.

### CROSS REFERENCE TO RELATED APPLICATION

This application is a continuation of U.S. patent application Ser. No. 10/841,045, filed May 7, 2004.

### BACKGROUND OF THE INVENTION

1. Field of the Invention

This invention relates to a composite roofing membrane having a top layer of a thermoplastic polymer, a middle layer of a fleece material, and a bottom layer of a modified bitumen. More particularly, the invention relates to a composite roofing membrane in which the top and bottom layers are reinforced with a polymer/glass scrim and methods of preparation thereof.

2. Description of Related Art

Single ply roofing membranes to cover flat and pitched roofs are known in the art of commercial roofing membranes. Some membranes comprise bottom and top polyolefin-based sheets with a fiber reinforcement scrim sandwiched between the sheets. To promote adhesion between the scrim and the polyolefin sheets, a highly flowable, functional-polyolefin is incorporated into one or both sheets as disclosed in U.S. Pat. No. 6,544,909.

Other membranes of the prior art consist of materials based on atactic polypropylene (APP) modified bitumen. Still other membranes consist primarily of materials based on styrene-butadiene-styrene (SBS) modified bitumen. Attachment of these membranes to underlying roof decks are accomplished with adhesives and/or screws. To adhere one membrane to another membrane to render the roof covering waterproof, the selvage edge of one membrane is overlapped with the selvage edge of the next membrane. A torch is then used to soften the membranes at their overlapped portions to achieve a seam sufficient to withstand weather conditions.

U.S. Pat. No. 6,134,856 discloses a roll roof membrane, and a method for its preparation, which obviates the use of a torch to achieve a seam between the overlapped portions of the membranes. The roof membrane comprises a support sheet having bonded on the top and bottom surfaces thereof layers comprising APP modified bitumen, a first selvage edge disposed in the top APP modified bitumen layer along one side of the membrane, a second selvage edge disposed in the bottom APP modified bitumen layer along the opposite side of the membrane, and wherein each of the selvage edges have a series of embossed ridges and valleys adopted to accept adhesives, the valleys extending substantially through the APP modified bitumen layers to the support sheet.

The method of preparing the roll roof membrane includes the steps of: a roll of support sheet is unwound and passed through an accumulator; the unwound sheet is dip coated by immersion in a coating vat containing molten compounded APP, asphalt, and one or more fillers and fire retardants; while the coatings are in a molten state, the selvage edge of the membrane is contacted with top side embosser; the APP modified bitumen layers are dried, cooled and solidified by floating the membrane in a water bath and the membrane is wound into a roll. A suitable liquid parting agent, such as a coconut oil, can be added to the bottom surface of the membrane to reduce the tendency for the membrane to stick during winding and subsequent handling.

### SUMMARY OF THE INVENTION

In accordance with the present invention, there is provided a composite roofing membrane for covering industrial and commercial flat and pitched roofs. The composite roofing membrane is characterized by the presence of a fleece material made of polyethylene or polyester having soft piles on its top and bottom surfaces with interstices therebetween to secure a top layer and a bottom layer thereto without the use of an adhesive or other securing means. Within this broad concept, the present invention includes two preferred embodiments.

The first embodiment of the composite roofing membrane comprises:

a top layer of a thermoplastic polymer, such as a thermoplastic polyolefin including the members selected from the group consisting of polyethylene, polypropylene, terpolymers of ethylene, propylene and diene monomers, ethylene-propylene copolymers, ethylene-butane copolymers, ethylene-hexane copolymers, ethylene-octane copolymers, propylene-C₄₋₈ alpha olefin copolymers, metallocene polyolefins, and polyvinyl chloride;

a middle layer of a fleece material, preferably made of polyethylene or polyester having soft, deep piles on the top and bottom surfaces thereof with interstices therebetween to allow the top and bottom layers in molten flowable form to flow therethrough; and

a bottom layer of modified bitumen composite wherein the modifier is selected from the group consisting of atactic polypropylene (APP), styrene-butadiene-styrene (SBS), styrene-ethylene-butadiene-styrene (SEBS), and styrene-butadiene rubber (SBR).

In another embodiment of the present invention both the bottom and top layers are reinforced by a reinforcing scrim or sheet fabricated from fiberglass, polyester, or fiberglass reinforced polyester. The scrim or sheet is preferably positioned in the middle of the layers, and typically has a thickness of from about 0.05 mm to about 0.5 mm.

Preferably, the composite roofing membrane contains a selvage edge disposed in the bottom layer along one side of the membrane for facilitating the positioning of two membranes laid down longitudinally and parallel to each other, wherein the selvage edge overlaps the other membrane.

In preparing the first preferred embodiment of the present invention, the top layer is extruded onto a calendaring roll and is concurrently laminated to the middle layer. Then the bottom bituminous layer is manufactured separately and laminated to the middle layer through calendaring rolls. The composite so-obtained is rolled up, preferably, with a release film so that the bottom layer does not stain the top layer. The rolled up product is packaged ready for shipment to the site of installation.

Applications of the finished product onto a roof deck may be accomplished by the following methods: cold applied adhesives, hot mop application of asphalt, torch application, and flood coat application.

### BRIEF DESCRIPTION OF THE DRAWINGS

FIG. 1 is a cross-sectional view of the composite roofing membrane of one embodiment of the present invention; and

FIG. 2 is cross-sectional view of the composite roofing membrane of another embodiment of the present invention.

### DETAILED DESCRIPTION OF THE INVENTION

In the drawings, like numerals denote like parts/components.

The invention hereinafter described is in reference to two preferred embodiments. In one preferred embodiment the composite roofing membrane comprises: a top layer of thermoplastic polymer; a middle layer of a fleece material; and a bottom layer of a modified bitumen composite. In another preferred embodiment the composite roofing membrane comprises: a top layer of thermoplastic resin reinforced by a polymeric scrim or sheet; a middle layer of a fleece material; and a bottom layer of modified bitumen composite reinforced by a polymeric scrim or sheet.

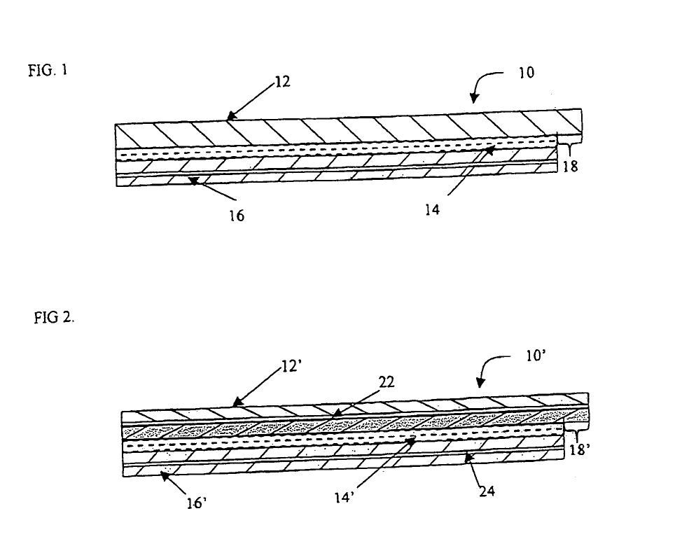

FIG. 1 illustrates in a cross-sectional view one preferred embodiment of the composite roofing membrane 10 of the present invention. The top layer 12 is a thermoplastic polymer having a thickness of from about 0.25 mm to about 2.5 mm or more, and preferably from about 1.0 mm to 2.0 mm. Specific thermoplastic polymers include polyethylene, polypropylene, terpolymers of ethylene, propylene and diene monomers, ethylene-propylene copolymers, ethylene-butane copolymers, ethylene-hexane copolymers, ethylene-octane copolymers, propylene-C₄₋₈ alpha olefin copolymers, metallocene polyolefins, and polyvinyl chloride. The layer can have conventional additives such as flame retardants, UV resistant materials and coloring agents. The use of pigments is preferred to obtain decorative effects. Such pigments include carbon black, titanium dioxide, chromium oxide, yellow iron oxide, ultramarine blue, red iron oxide, metal ferrites and mixtures thereof.

The middle layer 14 is of a fleece material of polyethylene or polyester having a thickness of form about 0.05 mm to about 0.5 mm and preferably from about 0.01 to 0.4 mm consisting of soft piles with interstices between the piles wherein the interstices are from about 0.1 mm to about 0.5 mm in diameter to allow wicking of flowable materials therethrough, i.e. the thermoplastic top layer and the bituminous bottom layer in flowable form. In terms of weight, the fleece material is typically of 3.5, 6.0 and 10.0 oz per yd². The fleece material is not a support scrim or sheet which provide strength to the composite membrane, it is an interlocking layer to facilitate bonding of the thermoplastic top layer to the bituminous bottom layer in order to create a mechanical lock between the top and bottom layers.

The bottom layer 16 is of a modified bitumen composite wherein the modifier is selected from the group consisting of atactic polypropylene (APP), styrene-butadiene-styrene (SBS), styrene-ethylene-butadiene-styrene (SEBS) and styrene-butadiene rubber (SBR). The layer has a thickness of form about 0.5 mm to about 20 mm, and preferably 5 mm to 15 mm.

Bitumen is well known and used in the prior art. The APP can be present in the APP modified bitumen in an amount from 5-30% w/w, preferably 7-15% w/w, and most preferably 12-22% w/w. The APP modified bitumen typically comprises 25-75% w/w bitumen and optionally small amounts of isotactic polypropylene (IPP) to enhance stiffness, fillers, fire retardants, and adjuvants. When used, IPP can be added in amounts of up to 20% w/w, fillers such as mica, talc, aluminum and CaCO₃ in amounts of 540% w/w, fire retardants such as aluminum trihydride (ATH), zinc borate and (CaO)₂(B₂O₃)₃.5H2O in the amounts of up to 40% w/w.

In practice, the APP modified bitumen and the above-listed additives are compounded at a temperature of from about 300° F. to about 450° F.

If desired, pigments in the amount of 0.1-5% w/w may be compounded with the APP modified bitumen along with the listed additives, such pigments include carbon black, titanium dioxide, chromium oxide, yellow iron oxide, ultramarine blue, red iron oxide, metal ferrites and mixtures thereof.

In order to render the appearances of the composite roof membrane uniformly smooth on top of the roof deck, the composite roof membrane is equipped with a selvage edge having a width of about 2-10 inches, preferably 3-9 inches, and most preferably 4-8 inches. A selvage edge 18 is disposed in the bottom layer 16 along one side of the membrane 10. As the composite membranes are positioned longitudinally and parallel to each other on installation, the selvage edge overlaps and covers the other membrane rendering the roof surface smooth and continuous without bumps.

FIG. 2 illustrates in a cross-sectional view another preferred embodiment of the composite roofing membrane 10′ of the present invention in which the top layer, middle layer, and bottom layer have essentially the same composition and configurational arrangement as described in the first preferred embodiment and illustrated in FIG. 1. However, in this embodiment the top layer and the bottom layer are equipped with a reinforcing scrim or sheet. Suitable reinforcing scrim or sheet is fabricated of fiberglass, polyester or fiberglass reinforced polyester. The thickness of the scrim or sheet can range from about 0.1-10 mm, and preferably 0.25-7.5 mm and have a tensile strength greater than about 80 pounds force per inch. As shown in FIG. 2, top layer 12′ is equipped with scrim 22 embedded preferably in the middle of the layer, and bottom layer 16′ is equipped with scrim 24 embedded preferably in the middle of the layer.

The composite roofing membrane can be manufactured using techniques and equipment used by the prior art. Typically, the top layer is extruded through a hanger die onto a calendaring roll to which layer the middle layer is concurrently laminated. The bottom layer is separately manufactured then laminated to the middle layer using a calendaring roll. The so-obtained composite membrane is preferably rolled up with a release film so that the bottom bituminous layer does not stain the top layer.

The composite roofing membrane typically has a width ranging from about 3 feet to 4 feet. The selvage edge disposed on the side of the membrane can have a width of about 2-10 inches, preferably 3-9 inches, and most preferably 4-8 inches.

Installation of the composite roofing membrane includes prior art accepted methods such as: cold applied adhesive application of modified and non-modified adhesives; torch application; hot mop application; and flood coat application.

### Parts List

Composite roofing membrane 10, 10′
Top layer 12, 12′
Middle layer 14, 14′
Bottom layer 16, 16′
Selvage edge 18, 18′
Reinforcing scrim in top layer 22
Reinforcing scrim in bottom layer 24

The present invention has been described with particular reference to two preferred embodiments thereof. However, it will be understood that changes and modifications may be made which are within the skill of the art. Such changes and modifications are intended to be covered limited only by the scope of the appended claims.

What is claimed is:

1. A composite roofing membrane for covering industrial and commercial flat and pitched roofs comprising three layers laminated together:
a top layer of a thermoplastic polymer;
a middle layer of a fleece material having soft, deep piles on the top and bottom surfaces thereof with interstices therebetween wherein the diameter of said interstices is of from about 0.1 mm to about 0.5 mm; and
a bottom layer of modified bitumen composite.

2. The composite roofing membrane of claim 1 wherein said top layer comprises a member selected from the group consisting of: polyethylene, polypropylene, terpolymers of ethylene, propylene and diene monomers, ethylene-propylene copolymers, ethylene-butane copolymers, ethylene-hexane copolymers, ethylene-octane copolymers, propylene-C₄₋₈ alpha olefin copolymers, metallocene polyolefins, and polyvinyl chloride.

3. The composite roofing membrane of claim 2 wherein said top layer has a thickness of from about 0.25 mm to about 2.5 mm.

4. The composite roofing membrane of claim 1 wherein said middle layer is polyethylene or polyester having a thickness of about 0.05 mm to about 0.5 mm.

5. The composite roofing membrane of claim 1 wherein the diameter of said interstices in said middle layer is of from about 0.1 mm to about 0.5 mm.

6. The composite roofing membrane of claim 1 wherein said fleece material has a weight of from about 3.5 oz per square yard to about 10.0 oz. per square yard.

7. The composite roofing membrane of claim 1 wherein said bottom layer of modified bitumen composite is modified by the presence of a modifier selected from the group consisting of: atactic polypropylene, styrene-butadiene-styrene, styrene-ethylene-butadiene-styrene, and styrene-butadiene rubber.

8. The composite roofing membrane of claim 7 wherein said bottom layer comprises:
of from about 25% to about 75% w/w bitumen;
of from at least 0.1% to about 20% w/w of an isotactic polypropylene;
of from about 5% to about 40% w/w of a filler selected from the group consisting of: mica, talc, aluminum and CaCO₃; and
of from about 0.0% to about 40% w/w of a fire retardant selected from the group consisting of: aluminum trihydride, zinc borate, and (CaO)₂(B₂O₃)₃.5H2O.

9. The composite roofing membrane of claim 1 wherein said bottom layer of modified bitumen further comprises a pigment in the amount of 0.1-5% w/w selected from the group consisting of: carbon black, titanium dioxide, chromium oxide, yellow iron oxide, ultramarine blue, red iron oxide, and metal ferrites.

10. The composite roofing membrane of claim 1 wherein said bottom layer is equipped with a selvage edge disposed on one side of said composite roofing membrane, said selvage edge being designed to partially overlap another roofing membrane when two roofing membranes are positioned longitudinally and parallel to each other upon installation over a roof deck.

11. A composite roofing membrane for covering industrial and commercial flat and pitched roofs comprising five layers laminated together:
a top layer of a thermoplastic polymer having a bottom surface;
a reinforcing scrim or sheet embedded in the bottom surface of the top layer or adhered to the bottom surface thereof, said reinforcing scrim or sheet comprising fiberglass, polyester or fiberglass reinforced polyester;
a middle layer of a fleece material having soft, deep piles on the top and bottom surfaces thereof with interstices therebetween wherein the diameter of said interstices is of from about 0.1 mm to about 0.5 mm;
a bottom layer of modified bitumen composite having a bottom surface and a reinforcing scrim or sheet embedded in the bottom surface of the bottom layer or adhered to the bottom surface thereof, said reinforcing scrim or sheet comprises fiberglass, polyester or fiberglass reinforced polyester.

12. The composite roofing membrane of claim 11 wherein said top layer comprises a member selected from the group consisting of: polyethylene, polypropylene, terpolymers of ethylene, propylene and diene monomers, ethylene-propylene copolymers, ethylene-butane copolymers, ethylene-hexane copolymers, ethylene-octane copolymers, propylene-C₄₋₈ alpha olefin copolymers, metallocene polyolefins, and polyvinyl chloride.

13. The composite roofing membrane of claim 12 wherein said top layer has a thickness of from about 0.25 mm to about 2.5 mm.

14. The composite roofing membrane of claim 11 wherein said middle layer is polyethylene or polyester having a thickness of about 0.5 mm to about 5.0 mm.

15. The composite roofing membrane of claim 11 wherein the diameter of said interstices in said middle layer is of from about 0.1 mm to about 0.5 mm.

16. The composite roofing membrane of claim 11 wherein said fleece material has a weight of from about 3.5 oz per square yard to about 10.0 oz. per square yard.

17. The composite roofing membrane of claim 11 wherein said bottom layer of modified bitumen composite is modified by the presence of a modifier selected from the group consisting of: atactic polypropylene, styrene-butadiene-styrene, styrene-ethylene-butadiene-styrene, and styrene-butadiene rubber.

18. The composite roofing membrane of claim 17 wherein said bottom layer comprises:
of from about 25% to about 75% w/w bitumen;
of from at least 0.1% to about 20% w/w of an isotactic polypropylene;
of from about 5% to about 40% w/w of a filler selected from the group consisting of: mica, talc, aluminum and CaCO₃; and
of from about 0.0% to about 40% w/w of a fire retardant selected from the group consisting of: aluminum trihydride, zinc borate, and (CaO)₂(B₂O₃)₃.5H2O.

19. The composite roofing membrane of claim 11 wherein said bottom layer of modified bitumen further comprises a pigment in the amount of 0.1-5% w/w selected from the group consisting of: carbon black, titanium dioxide, chromium oxide, yellow iron oxide, ultramarine blue, red iron oxide, and metal ferrites.

20. The composite roofing membrane of claim 11 wherein said bottom layer is equipped with a selvage edge disposed on one side of said composite roofing membrane, said selvage edge being designed to partially overlap another roofing membrane when two roofing membranes are positioned longitudinally and parallel to each other upon installation over a roof deck.
